(19) United States
(12) Patent Application Publication
(10) Pub. No.: US 2017/0357765 A1
(43) Pub. Date: Dec. 14, 2017

(54) USER INTERFACE FOR CONFIGURABLY DISPLAYING REAL-TIME DATA FOR MULTIPLE PATIENTS

(71) Applicant: MEDICAL INFORMATICS CORPORATION, HOUSTON, TX (US)

(72) Inventors: EMMA K. FAUSS, HOUSTON, TX (US); ALEXANDER CSICSERY-RONAY, TAOS, NM (US)

(21) Appl. No.: 15/621,906

(22) Filed: Jun. 13, 2017

Related U.S. Application Data
(60) Provisional application No. 62/349,580, filed on Jun. 13, 2016.

(51) Int. Cl. G06F 19/00; G06F 3/0484; G06F 17/30; G06Q 50/22

(52) U.S. Cl. CPC G06F 19/3406; G06Q 50/22; G06F 3/04842; G06F 3/04847; G06F 17/30861; G06F 19/322

(57) ABSTRACT

A configurable web-based user interface allows a clinical staff person to monitor real-time or near real-time patient data for selected multiple patients. The clinical staff person may select which patients to include in the user interface, which may be patients in more than one facility. The clinical staff person may also configure the user interface to display vital signs and other physiological data, including computed indices, as desired. Embodiments allow the clinical staff person to select a patient of interest and instantiate another monitor for that selected patient to display real-time or historical data as desired.

### TECHNICAL FIELD

The present invention relates to the field of medicine, and in particular to a user interface for displaying real-time data for multiple patients.

### BACKGROUND ART

Multiple vendors sell central monitoring stations for clinical settings. These central monitoring stations are expensive, are typically limited to certain physical networks, and are not good at sharing or distributing information beyond the central monitoring station. If a physician or other clinical staff wants to monitor a set of patients of interest to them, either from another location in the hospital or remotely, they typically cannot do so. Thus, clinical staff wanting to assess the current state and trends of patients of they are monitoring have limited abilities to do so.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a screenshot of a web-based user interface for configurably monitoring a selected group of patients in real-time according to one embodiment.

FIG. 2 is a screenshot of a web-based user interface for configurably monitoring a selected group of patients in real-time according to one embodiment.

FIG. 3 is a screenshot of a web-based user interface for configurably monitoring a selected group of patients in real-time according to one embodiment.

FIG. 4 is a screenshot of a web-based user interface for selecting a group of patients for display in a web-based user interface for configurably monitoring the selected group of patients in in real-time according to one embodiment.

FIG. 5 is a flowchart illustrating a technique for monitoring multiple patients in real-time according to one embodiment.

FIG. 6 is a block diagram of a system for collecting physiological data, generating the predictive information, and displaying the predictive information in a user interface as illustrated in FIGS. 1-4, according to one embodiment.

FIG. 7 is a block diagram of a programmable device used in the system of FIG. 6 according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment. The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

As used herein, the term “a computer system” can refer to a single computer or a plurality of computers working together to perform the function described as being performed on or by a computer system.

As used herein, the term “processor” or “processing element” can refer to a single hardware processing element or a plurality of hardware processing elements that together may be programmed to perform the indicated actions. The hardware processing elements may be implemented as virtual hardware processing elements of a virtual programmable device hosted on a physical hardware device. Instructions that when executed program the processing element to perform an action may program any or all of the processing elements to perform the indicated action. Where the processing element is one or more multi-core processors, instructions that when executed program the processing element to perform an action may program any or all of the multiple cores to perform the indicated action.

As used herein, the term “medium” can refer to a single physical medium or a plurality of media that together store the information described as being stored on the medium.

As used herein, the term “memory” can refer to a single memory device or a plurality of memory devices that together store the information described as being stored on the medium. The memory may be any type of storage device, including random access memory, read-only memory, optical and electromechanical disk drives, etc.

As used herein, the term “vital signs” can refer to clinical measurements, commonly, but not exclusively pulse rate, temperature, respiration rate, and blood pressure, that indicate the state of a patient's essential body functions

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation.

Monitoring stations are a key part of a clinical facility. A monitor watcher, typically a nurse or a trained monitor watcher, is tasked to monitor patients. The monitor watcher may monitor patients to look for various kinds of situations, including: (a) Does a patient require immediate attention? (b) Is a patient trending downward? and (c) Will the patient require attention soon? In addition, a monitor watcher may need to alert an appropriate care provider to a condition, or to review a specific event.

In addition to monitor watchers, care providers and other specialists, whether physicians or other types of specialists can make use of monitoring station to (a) check on patient status (to evaluate impact of an intervention)? or (b) review how the patient trending from baseline (improving, declining, stable, or unstable). The care provider needs to be alerted to a patient problem and may need to evaluate the patient's condition for immediate action.

While central monitoring stations have been effective in some circumstances, as indicated above, they have limitations that make providing a monitoring facility difficult. Conventional central monitoring stations are not a flexible as would be desired. For example, (a) the number of patients that can be monitored by a central monitoring status is fixed, and (b) a central monitoring station from one vendor is unable to monitor patients whose bedside equipment is made by a different vendor.

A web-based user interface that relies upon an underlying vendor-agnostic platform provides a solution to these problems. In one embodiment, the underlying vendor-agnostic platform is the SICKBAY™ platform from Medical Informatics Corp. (SICKBAY is a trademark of Medical Informatics Corp.) By allowing the platform to instantiate a web-based application that provides for a configurable monitoring station that can monitor any number of patients from beds and facilities with equipment from any vendor, the deficiencies of central monitoring stations can be overcome. Because the monitoring application is web-based, the monitoring application can be used on nearly any type of device that can support web-based applications and display a graphical user interface, which includes fixed installations as well as mobile devices. Because the underlying platform can transform vendor-specific patient data into vendor-agnostic patient data, the configurable monitoring application user interface can allow monitor watchers and care providers the ability to be more flexible in what they monitor.

In one embodiment, a high-level screen provides a graphical user interface (GUI) 100 that shows areas or badges for each monitored or selected patient. All watched or active patients may be seen from one view. Preferably the monitor screen is capable of displaying all of the monitored patients without scrolling, but some embodiments may allow scrolling the GUI 100 when more patients are monitored than can be fit into the current display screen.

In one embodiment, clinical staff may access other patient-based applications after selecting on a patient of interest, such as by clicking on the corresponding portion of the GUI 100 for that patient. Because the GUI 100 is web-based, the clinical staff would not need to travel to a central monitoring station at a fixed location, but may view the monitoring screen on any web-enabled device and at any location. Instead of being restricted to a pre-selected set of patients visible at the central monitoring station, the clinical staff person may view any or all active patients of interest and easily configure the display to select patients of interest as well as patient data of interest. In addition, by simply adding another programmable device capable of running a web browser, additional screens may be added easily if more patients need to be monitored. So a monitoring station may be reconfigured without hardware or software changes, simply by instantiating another copy of the monitoring application on a screen that may have been used for other purposes, and when the need for the extra monitor display real estate ends, the screen used for that monitoring can be made available for other purposes, again without provisioning of equipment or hardware or software changes.

In various embodiments, the monitoring system allows a user to perform desired monitoring actions, including (a) selecting a patient; (b) access historical patient information (including labs, meds, and EMR patient records if available); (c) access patient history information; (d) perform active patient monitoring of real-time data; and (e) select monitors from available patient-specific monitors. The user in various embodiments may perform actions in the monitoring system, including (a) adding patient to the list of patients being monitored; (b) tag events for review; (c) send events for review to an appropriate care provider; and (d) annotate tagged events. The monitoring system may be integrated into the facilities electronic medical records (EMR) system.

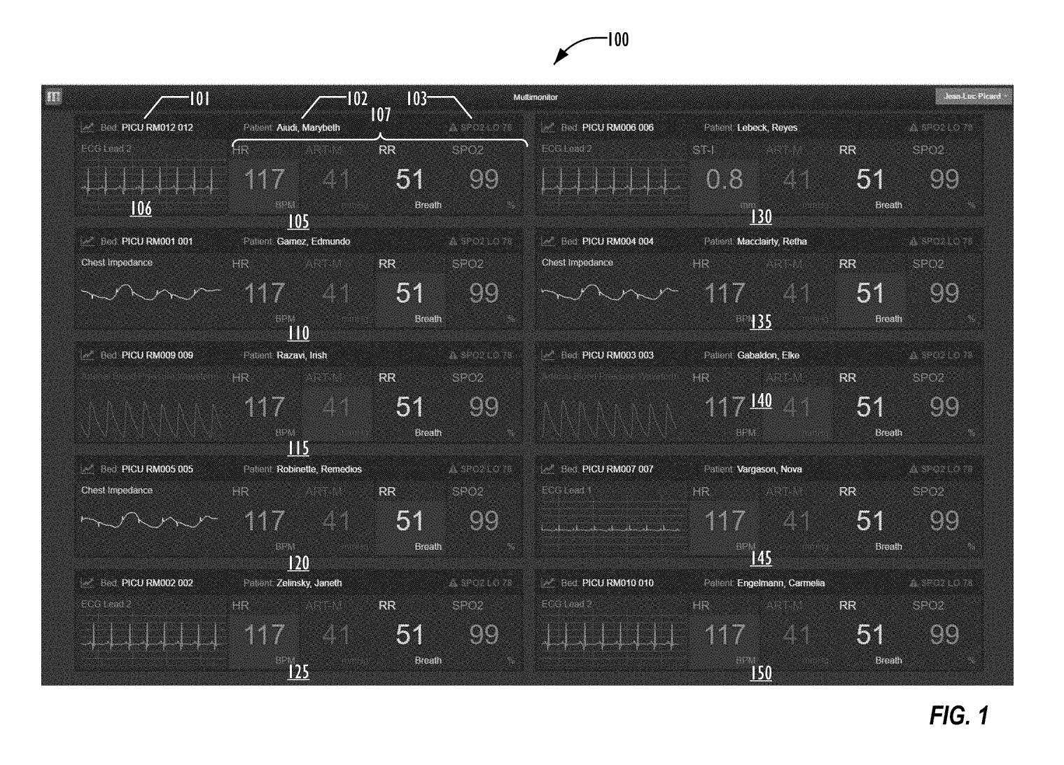

FIG. 1 is a screenshot of a GUI 100 of a monitoring system according to one embodiment. The GUI 100 allows presentation and display of objects that are useful to a monitor watcher or care provider, including (a) the patient's name; (b) the bed identifier; (c) active alarms; (d) vital signs; (e) waveforms, such as electrocardiogram (ECG) leads. Preferably, the GUI 100 allows the user to view data trends, perform review or analysis of the real-time data, and set guard rails to alert care providers if patient data is outside of a threshold. The patient real-time data illustrated in FIG. 1 is illustrative and by way of example only, does not display actual patient information, and is not intended to display accurate medical conditions, as should be clear from the identical patient numerical and waveform data displayed for multiple patients.

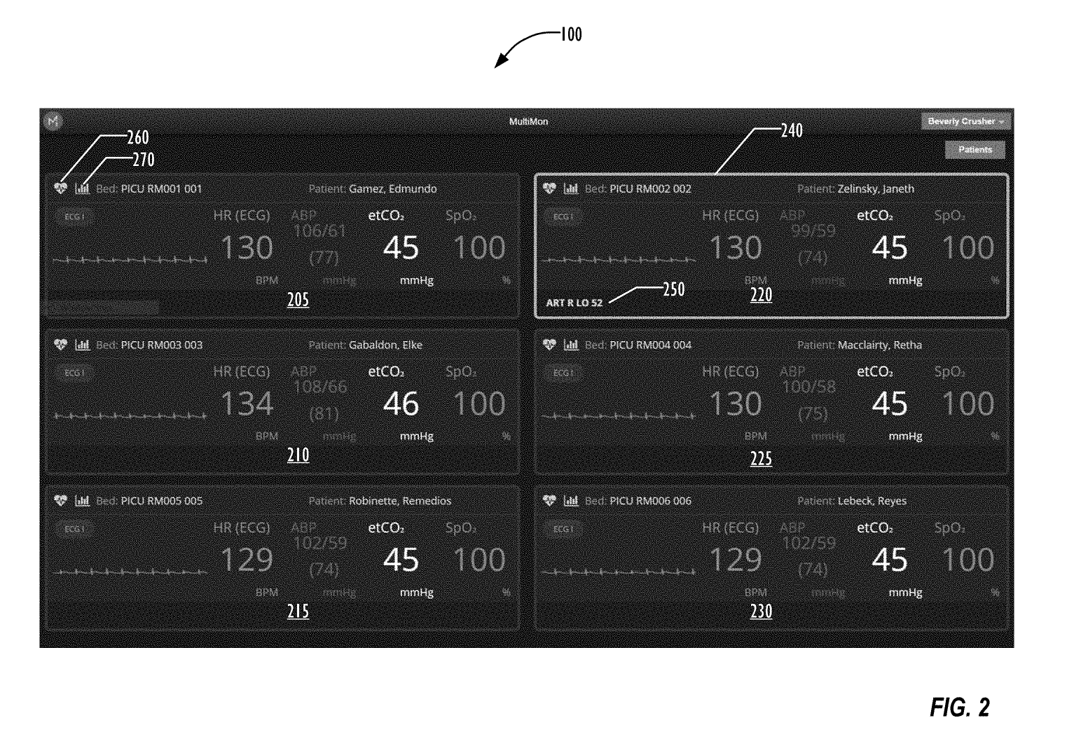

In one embodiment, the GUI 100 is divided into a configurable number of badges or areas, each specific to a patient. In the example configuration of FIG. 1, 10 patient areas are displayed 105-150; however, the number of patient areas is configurable, as illustrated by the screenshot of FIG. 2, in which only six patient areas 205-230 are displayed. Each patient area 105-150 comprises a patient bar that includes information such as a bed identifier 101 and a patient name 102. Additional patient information can be provided as desired, and the arrangement of the bed identifier and patient name widgets is illustrative and by way of example only.

In addition to identifying information such as the bed identifier 101 and patient name 102, in the embodiment of FIG. 1, an alarm area 103 may be provided to indicate that the patient is currently in an alarm condition, with an indication of the alarm type and relevant data value. In FIG. 1, alarm indication 103 that the patient has a low saturation of peripheral oxygen (SPO2) reading.

Each patient badge or area 105-150 contains a real-time waveform or graph of a selected patient data and a vital signs area 107 for one or more other types of patient data. For example, in FIG. 1, patient Marybeth Audi is being monitored with an ECG Lead 2 waveform 106. The patient has a current heartrate (HR) of 117 beats per minute (BPM), a mean arterial blood pressure (ART-M) of 41 mm/Hg, a respiration rate of 51 breaths per minute, and an SPO2 level of 99%. The user of the GUI 100 may configure what waveforms and numerical data is displayed, allowing the clinician or monitor watcher to select which vital signs of general interest should be displayed for each patient. The data in FIG. 1 is not intended to be medically accurate, thus no meaning should be given to the SPO2 reading of 78 in the alarm area 103, even though the SPO2 reading in the vital signs area 107 indicates an SPO2 level of 99.

As illustrated in FIG. 1, the display in the GUI 100 for each patient may contain different real-time (or near real-time) physiological data as desired. For example, as illustrated in FIG. 1, some patients are showing ECG lead graphs, while others are showing graphs of chest impedance or arterial blood pressure. In addition to the selected graphs, the GUI 100 may be configured to display certain vital signs for each patient. The GUI 100 may allow the clinician to select which vital signs of general interest should be displayed. So, for example, while patient areas 105-125 and 135-150 are displaying heart rate, mean arterial blood pressure, respiration rate, and oxygenation percentage, while patient area 130 is displaying an ST-I of 0.8 mm instead of heart rate.

The configuration of FIG. 1 is similar to that displayed by a traditional central monitoring station, but is easily configurable by each clinician as desired. Unlike a conventional central monitoring station, which is typically limited to displaying data collected by devices produced by the manufacturer of the central monitoring station, the GUI 100 can make use of the capabilities of an underlying data collection platform that can capture physiological data from any type of sensor or device that can collect and transmit data. Also unlike a conventional central monitoring station, the patients selected for display may be in different facilities, as long as each facility is running an underlying platform that allows transmission of data to the clinician's device. Such a platform may be the Sickbay™ platform from Medical Informatics Corp. Thus, a physician with patients in multiple facilities would have the ability to monitor all of those patients at a single user interface, without having to travel to the central monitoring stations of each facility.

In one embodiment, clicking on a waveform portion of the display may allow the clinician to switch between the current waveform and other waveforms, such as a different ECG lead or a completely different type of physiological data. Similarly, clicking on the numeric vital signs areas may allow the user to cycle through or otherwise select a different numeric data element to display. Although expressed as clicking on the element, one of skill in the art will recognize that any type of user selection technique may be used. For example, if the clinical staff person's device displaying the GUI 100 is touch-enabled, the user may be able to touch the portion of the screen for that user interaction element and cause selection of that element or change that element. In one embodiment, a first click on a vital sign causes the selection of that vital sign, and subsequent clicks may cause cycling through vital signs in a pre-defined group of vital signs.

In one embodiment, the GUI 100 saves the state of the display, so that if a clinician switches away from the GUI 100 and returns, the display returns to the same state as before, albeit with current data in the display.

Color may be used as desired in the user interface. The screenshot of FIG. 1 uses conventional green, red, white, and blue colors for vital signs and waveforms, but the colors may be configured as desired. For example, a clinician with a red-green colorblindness may configure the display to use other colors to help the clinician distinguish the elements on the display, something that is not possible in conventional central monitors.

As a web-based interface, in some embodiments, different tabs or windows may be opened when selecting elements in the user interface. So, for example, a tab opened in the GUI 100 may use conventional browser capabilities to allow the tab to be dragged to a different screen from the rest of the interface, allowing (for example) historical and real-time monitoring data to be displayed at the same time.

For example, no capability exists today for centralized ventilator monitoring, but this GUI 100 would allow composing a screen that provided ventilator monitoring for multiple patients. In some embodiments, calculated data, such as algorithmically derived risk indices may be displayed instead of or in addition to captured sensor data.

In one embodiment, illustrated in the screenshot of FIG. 2, one or more user interaction elements, such as buttons, may be provided to allow the clinician to select a different view, such as an historical data view for that patient (270) or a more detailed view of real-time data for the specific patient (260).

In FIG. 2, an alternate technique for illustrating the presence and severity of an alarm may be provided by the GUI 100. In this embodiment, instead of placing the alarm indicator at the top right of the patient area, the indicator 250 is placed at the lower left. In addition, when the alarm is indicated, in addition to displaying the numerical alarm indicator, a visual indicator may highlight that patient area 220 is indicating an alarm condition. In the example of FIG. 2, patient area 220 is surrounded by a highlight border 240 of the same color as the alarm indicator 250, making the presence of the alarm indication more noticeable to the monitor watcher.

In some embodiments, more than a single value may be displayed for a given vital sign. In the example of FIG. 2, instead of a single ART-M mean blood pressure indication, an arterial blood pressure (ABP) indication may indicate both systolic and diastolic pressures as well as a mean blood pressure value.

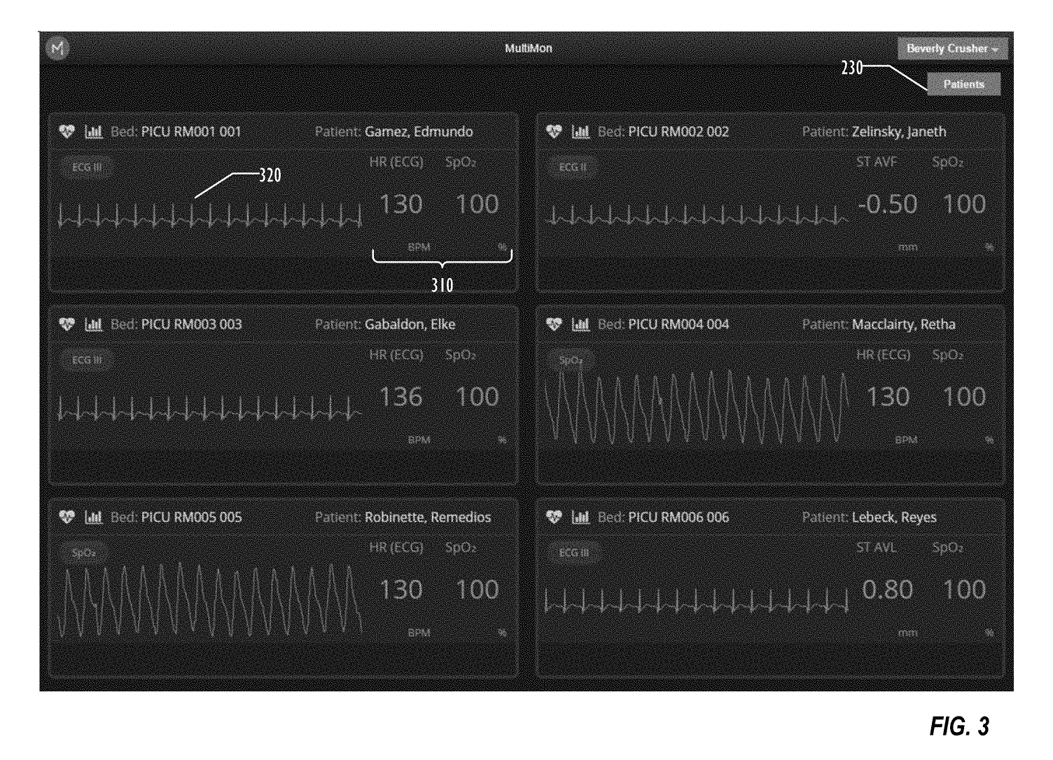

In FIGS. 1 and 2, four vital signs are displayed in the vital signs area 107. Embodiments may configure any number of vital signs to be displayed in the vital signs area. From time to time, certain vital signs may be configured for display, but may not be displayable, because the patient data is unavailable, such as when a patient has pulled off a sensor device. In such a situation, in one embodiment the vital signs area 107 may shrink, showing only the available vital signs. In other environments, the vital signs area 107 may remain the same, but no data will be displayed in the area for the missing vital sign; alternately, a special indicator of missing data may be displayed. FIG. 3 is a screenshot of the embodiment of FIG. 2 in which either only two vital signs are configured for display or where only two of the configured vital signs are available. In this embodiment, the vital signs area 310 may shrink to display just the two available configured vital signs and the waveform area 320 may expand, providing a larger area for the waveform display.

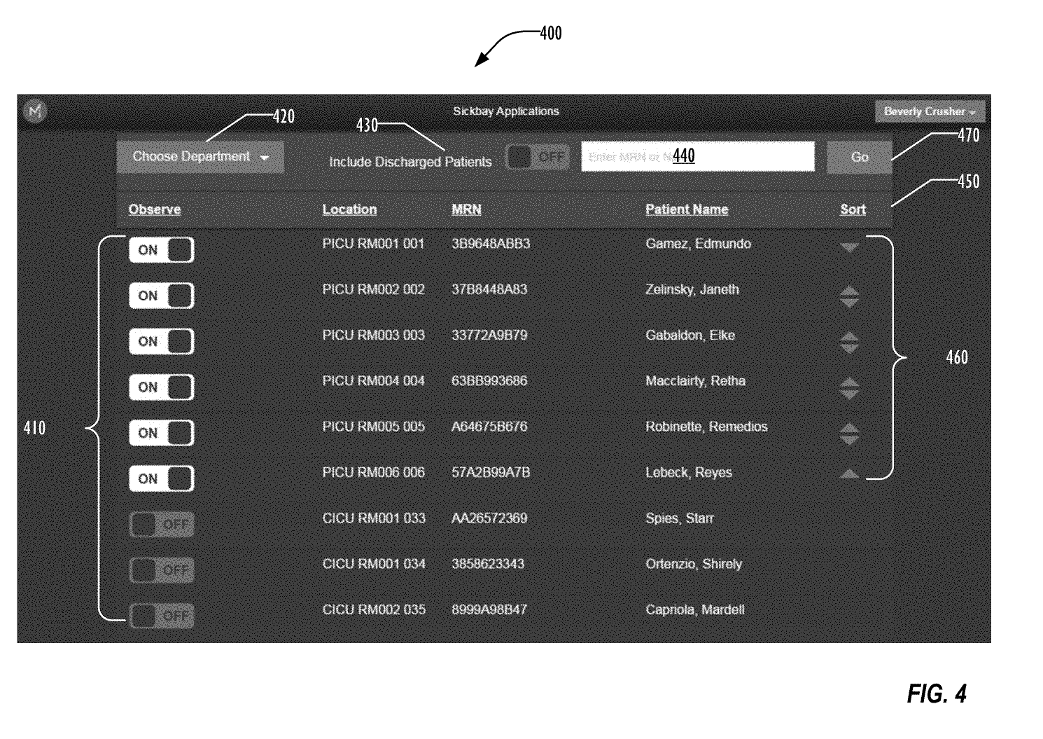

FIG. 2 also displays a user interaction element 230, such as a button, that when selected may allow the monitor user to select patients for display in the GUI 100. FIG. 4 is a screenshot illustrating a patient configuration window 400 according to one embodiment. In this embodiment, a number of available patients are displayed in area 410, allowing the monitor user to indicate whether the patient should be displayed, using a slide button that toggles between indicating displayed (“ON”) or not displayed (“OFF”). Other GUI techniques for selecting items, including check boxes, may be used.

Another user interaction element 420 allows selecting a department of the medical facility, using a drop-down menu selection widget or any other type of selection widget, so that the display of available patients may be limited to one or more selected departments if desired. In one embodiment, a selector 430 (in FIG. 4, an ON/OFF slide button) may allow the user to indicate whether discharged patients should be displayed, or whether the display should be limited to currently admitted patients. A text entry box 440 may also provide a way for a user to enter a patient name or other identifying information, causing the monitor application to search facility records for a patient or patients that matches the entered text. In various embodiments, the patients are listed in a tabular form, with a sorting bar 450 allowing the user to click on a heading for a table column to cause sorting by that column. In one embodiment, a sorting control 460 may allow manually ordering rows of the table, indicating whether a row should be moved up or down in the table. Once the list and order of patients has been established, a “Go” button or other user interaction element 470 may be selected to indicate configuration has completed, causing the GUI 100 to be configured with the selected patients ordered as indicated in the window 400. The designation “Go” is illustrative and by way of example only, and other techniques for indicating completion may be used, including automatically completing configuration if no further changes are made in a predetermined time period.

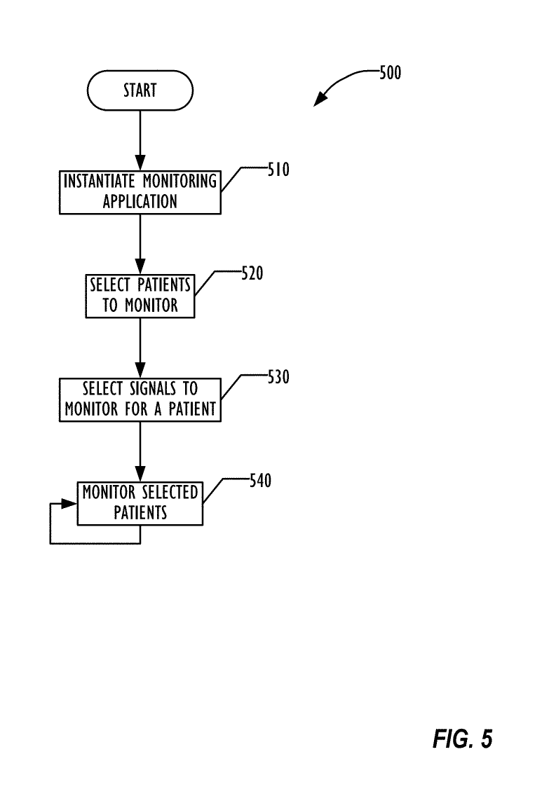

FIG. 5 is a flowchart 500 illustrating execution of a monitoring system as described above according to one embodiment. In block 510, the monitoring application is instantiated in an underlying platform. In block 520, a selection of patients to be monitored is made. In block 530, the signals to be monitored for each patient may be selected. Then in block 540 the selected patients may be monitored, displaying the monitored data in the GUI 100 as described above.

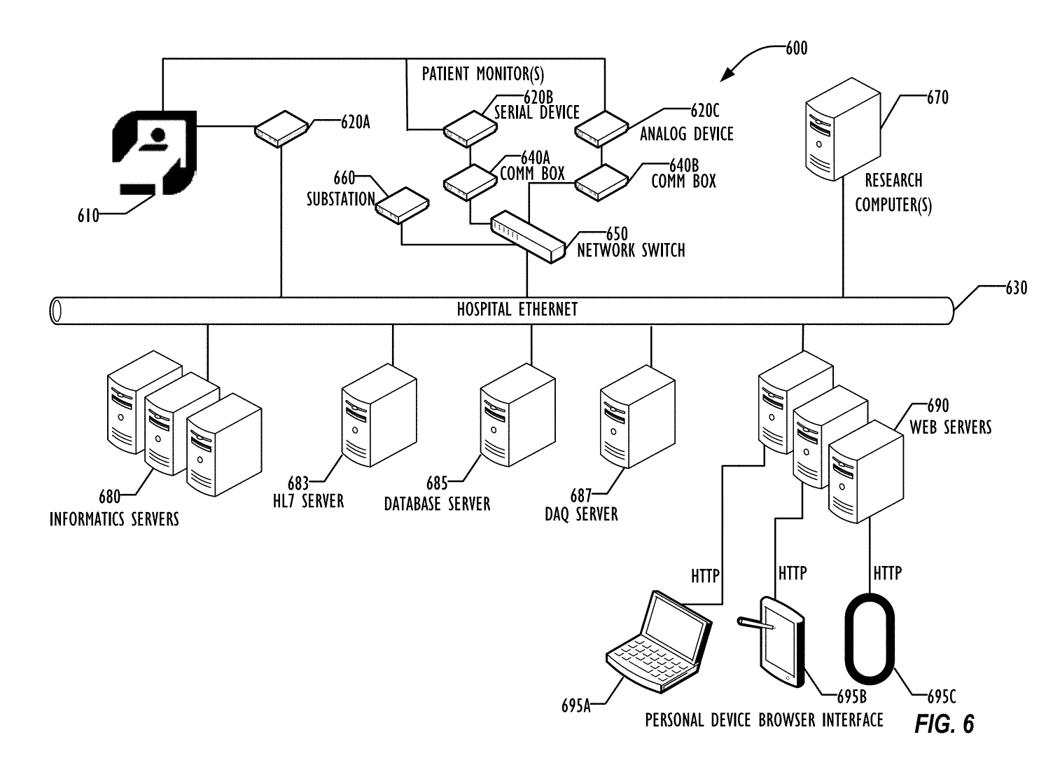

FIG. 6 is a block diagram illustrating a system 600 for collecting, archiving, and processing arbitrary data in a healthcare environment that can deploy a GUI 100 as described above, according to one embodiment.

As illustrated, there are five types of servers: the data acquisition (DAQ) server 687, the informatics server(s) 680, the database server 685, the Health Level 7 (HL7) server 683, and the web server(s) 690. Any number of any of the types of servers may be deployed as desired. All of the servers 680-690 connect to each other and the bedside monitors via one or more hospital networks 630. Although illustrated as a single hospital Ethernet network 630, any number of interconnected networks may be used, using any desired networking protocols and techniques.

Also connected to the hospital network 630 are a number of bedside monitors for monitoring physiological data for a patient in bed 610. These bedside monitors may include network connected monitors 620A, which can deliver digital physiological data to the hospital network 630, serial devices 620B, which produce digital data but are not directly connected to a network, and analog devices 620C, which produce analog data and are not directly connected to a network. Communication boxes 640A and 640B allow connecting the serial devices 620B and analog devices 620C, respectively, to the hospital network 630, typically through a network switch 650. In addition, a sub-station 660 may be also connected to the network 630 via the network switch 650 for performing data manipulation and time synchronization as described below. Any number of bedside monitor devices 620 may be used as determined advisable by physicians and other clinical staff for the patient in bed 610.

Although as illustrated in FIG. 6 the bedside monitors and associated communication devices are connected directly or indirectly to the hospital network 630, remote bedside monitoring devices may be used as part of the system 600, such as home monitoring devices, connected to the hospital network 630 indirectly through the Internet or through other communication techniques.

Additionally, one or more research computers 670 may be connected, directly or indirectly, to the hospital network 630, allowing researchers to access aggregated data collected from bedside monitors 620 for performing analytics and development.

The web servers 690 are configured for communicating with personal devices such as laptop 695A, tablet 695B, or smart phone 695C via a web browser interface using HyperText Transport Protocol (HTTP). In one embodiment, the system 600 is a Sickbay Platform provided by Medical Informatics Corp. of Houston, Tex. More detail about the system 600 can be found in U.S. Pat. Pub. No. 2015/0142475A1, “Distributed Grid-Computing Platform for Collecting, Archiving, and Processing Arbitrary Data in a Healthcare Environment,” U.S. patent application Ser. No. 14/548,433, filed Nov. 20, 2014, which is incorporated herein by reference in its entirety for all purposes.

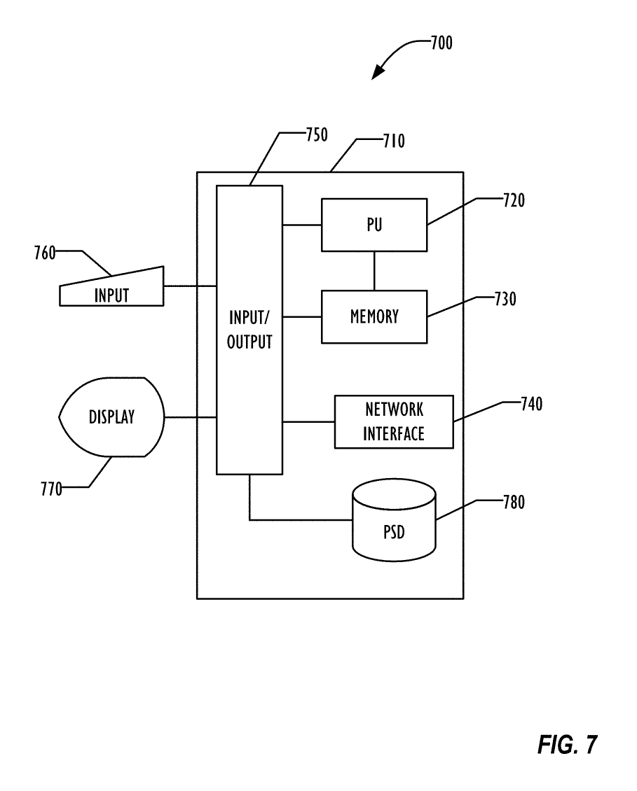

Referring now to FIG. 7, an example computer 700 for use as one of the servers 280-290 is illustrated in block diagram form. Example computer 700 comprises a system unit 710 which may be optionally connected to an input device or system 760 (e.g., keyboard, mouse, touch screen, etc.) and display 770. A program storage device (PSD) 780 (sometimes referred to as a hard disc) is included with the system unit 710. Also included with system unit 710 is a network interface 740 for communication via a network with other computing and corporate infrastructure devices (not shown). Network interface 740 may be included within system unit 710 or be external to system unit 710. In either case, system unit 710 will be communicatively coupled to network interface 740. Program storage device 780 represents any form of non-volatile storage including, but not limited to, all forms of optical and magnetic, including solid-state, storage elements, including removable media, and may be included within system unit 710 or be external to system unit 710. Program storage device 780 may be used for storage of software to control system unit 710, data for use by the computer 700, or both.

System unit 710 may be programmed to perform methods in accordance with this disclosure. System unit 710 comprises a processor unit (PU) 720, input-output (I/O) interface 750 and memory 730. Processor unit 720 may include any programmable controller device, such as microprocessors available from Intel Corp. and other manufacturers. Memory 730 may include one or more memory modules and comprise random access memory (RAM), read only memory (ROM), programmable read only memory (PROM), programmable read-write memory, and solid-state memory. One of ordinary skill in the art will also recognize that PU 720 may also include some internal memory including, for example, cache memory.

Embodiments may be implemented in one or a combination of hardware, firmware, and software. Embodiments may also be implemented as instructions stored on a computer-readable storage medium, which may be read and executed by at least one processing element to perform the operations described herein. A computer-readable storage medium may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

Embodiments, as described herein, may include, or may operate on, logic or a number of components, modules, or mechanisms. Modules may be hardware, software, or firmware communicatively coupled to one or more processing elements in order to carry out the operations described herein. Modules may be hardware modules, and as such, modules may be considered tangible entities capable of performing specified operations and may be configured or arranged in a certain manner. Circuits may be arranged (e.g., internally or with respect to external entities such as other circuits) in a specified manner as a module. The whole or part of one or more programmable devices (e.g., a standalone client or server computer system) or one or more hardware processing elements may be configured by firmware or software (e.g., instructions, an application portion, or an application) as a module that operates to perform specified operations. The software may reside on a computer readable medium. The software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Where modules are temporarily configured, each of the modules need not be instantiated at any one moment in time. For example, where the modules comprise a general-purpose hardware processing element configured using software; the general-purpose hardware processing element may be configured as respective different modules at different times. Software may accordingly program a hardware processor, for example, to constitute a particular module at one instance of time and to constitute a different module at a different instance of time. Modules may also be software or firmware modules, which operate to perform the methodologies described herein.

While certain exemplary embodiments have been described in details and shown in the accompanying drawings, it is to be understood that such embodiments are merely illustrative of and not devised without departing from the basic scope thereof, which is determined by the claims that follow.

We claim:

1. A web-based medical patient monitoring system for displaying physiological data for a configurable plurality of patients, comprising:
a processor; and
a memory, coupled to the processor, on which are stored instructions for receiving and displaying physiological data for a plurality of patients, comprising instructions that when executed cause the processor to:
receive a selection of patients for inclusion in the monitoring system;
display real-time patient data for each of the selection of patients in a graphical user interface, comprising a plurality of patient specific areas, each comprising:
a patient identification area identifying a patient associated with the patient specific area;
a waveform area, configured to display a selected waveform of a real-time patient data type corresponding to the patient;
a vital signs area, configured to display a plurality of real-time vital signs for the patient; and
an alarm area, configured to display an alarm indication responsive to an alarm condition for the patient.

2. The monitoring system of claim 1, wherein the instructions that when executed cause the processor to display real-time patient data comprise instructions that when executed cause the processor to expand the waveform area and shrink the vital signs area responsive to an absence of a vital sign of the plurality of real-time vital signs.

3. The monitoring system of claim 1, wherein the instructions further comprise instructions that when executed cause the processor to display a graphical user interface for selecting patients from a set of available patients for inclusion in the monitoring system.

4. The monitoring system of claim 1, wherein the instructions further comprise instructions that when executed cause the processor to indicate an alarm condition in a patient specific area of the graphical user interface responsive to an alarm condition existing in the real-time patient data for the corresponding patient.

5. The monitoring system of claim 1, wherein graphical user interface further comprises a user interaction element that when selected causes the processor to instantiate an application for displaying historical patient data for the corresponding patient.

6. The monitoring system of claim 1, wherein the plurality of patients comprises a plurality of patients at a plurality of medical facilities.

7. The monitoring system of claim 1, wherein the plurality of patients comprises a plurality of patients whose real-time patient data is collected by equipment from a plurality of vendors.

8. A method of displaying real-time patient data for a configurable number of patients, comprising:
receiving a selection of patients for inclusion in a web-based medical patient monitoring system for displaying physiological data for a configurable plurality of patients;
displaying real-time patient data for each of the selection of patients in a graphical user interface, comprising a plurality of patient specific areas, comprising:
displaying information identifying a patient associated with the patient specific area in a patient identification area;
displaying a selected waveform of a real-time patient data type corresponding to the patient in a waveform area of the patient specific area;
displaying a plurality of real-time vital signs for the patient in a vital signs area of the patient specific area; and
displaying an alarm indication responsive to an alarm condition for the patient in an alarm area of the patient specific area.

9. The method of claim 8, further comprising expanding the waveform area and shrinking the vital signs area responsive to an absence of a vital sign of the plurality of real-time vital signs.

10. The method of claim 8, further comprising displaying a graphical user interface for selecting patients from a set of available patients for inclusion in the monitoring system.

11. The method of claim 8, further comprising highlighting the patient specific area responsive to an alarm condition existing in the real-time patient data for the corresponding patient.

12. The method of claim 8, instantiating an application for displaying historical patient data for the corresponding patient responsive to selecting a user interaction element displayed in the patient specific area.

13. The method of claim 8, wherein the plurality of patients comprises a plurality of patients at a plurality of medical facilities.

14. The method of claim 8, wherein the plurality of patients comprises a plurality of patients whose real-time patient data is collected by equipment from a plurality of vendors.

15. A non-transitory machine-readable medium on which are stored instructions for a real-time monitoring system for a plurality of patients; comprising instructions that when executed cause a machine to:
receive a selection of patients for inclusion in the monitoring system;
display real-time patient data for each of the selection of patients in a graphical user interface, comprising a plurality of patient specific areas, each comprising:
a patient identification area identifying a patient associated with the patient specific area;
a waveform area, configured to display a selected waveform of a real-time patient data type corresponding to the patient;
a vital signs area, configured to display a plurality of real-time vital signs for the patient; and
an alarm area, configured to display an alarm indication responsive to an alarm condition for the patient.

16. The machine-readable medium of claim 15, wherein the instructions that when executed cause the machine to display real-time patient data comprise instructions that when executed cause the machine to expand the waveform area and shrink the vital signs area responsive to an absence of a vital sign of the plurality of real-time vital signs.

17. The machine-readable medium of claim 15, wherein the instructions further comprise instructions that when executed cause the machine to display a graphical user interface for selecting patients from a set of available patients for inclusion in the monitoring system.

18. The machine-readable medium of claim 15, wherein the instructions further comprise instructions that when executed cause the machine to indicate an alarm condition in a patient specific area of the graphical user interface responsive to an alarm condition existing in the real-time patient data for the corresponding patient.

19. The machine-readable medium of claim 15, wherein graphical user interface further comprises a user interaction element that when selected causes the machine to instantiate an application for displaying historical patient data for the corresponding patient.

20. The machine-readable medium of claim 15, wherein the plurality of patients comprises a plurality of patients at a plurality of medical facilities.

21. The machine-readable medium of claim 15, wherein the plurality of patients comprises a plurality of patients whose real-time patient data is collected by equipment from a plurality of vendors.
